(19) United States
(12) Patent Application Publication
(10) Pub. No.: US 2013/0226979 A1
(43) Pub. Date: Aug. 29, 2013

(54) SYSTEMS AND METHODS FOR MULTI-DEVICE RENDERING OF MULTIMEDIA PRESENTATIONS

(71) Applicant: Brainshark, Inc., (US)

(72) Inventors: Christopher Caruso, Reading, MA (US); Joseph Edward Gustafson, Sherborn, MA (US); Gregory Allen Flynn, Acton, MA (US)

(73) Assignee: Brainshark, Inc., Waltham, MA (US)

(21) Appl. No.: 13/654,119

(22) Filed: Oct. 17, 2012

Related U.S. Application Data
(63) Continuation of application No. 61/547,970, filed on Oct. 17, 2011.

(51) Int. Cl. G06F 17/30

(52) U.S. Cl. CPC G06F 17/30076
USPC 707/827

(57) ABSTRACT

A new approach is proposed that contemplates systems and methods to support multi-device rendering of multimedia presentations by allowing users of various presentation preparation and display programs to make their work product available for viewing on various hardware and software platforms on which the presentations would not otherwise be rendered correctly. First, multimedia presentations created by a user/author in their original format are generated and uploaded to a centralized repository. The uploaded presentations are then converted to a set of intermediate files in a format different from the original format of the presentations, wherein the intermediate files can be downloaded to and rendered on the hardware and software platform of a specific device associated with a viewer while maintaining the visual and audio integrity of the original presentation.

### RELATED APPLICATIONS

This application claims priority to U.S. Provisional Patent Application No. 61/547,970, filed Oct. 17, 2011, and entitled “MULTI-DEVICE RENDERING OF MULTIMEDIA PRESENTATIONS,” and is hereby incorporated herein by reference.

### FIELD OF THE INVENTION

The invention relates generally to the presentation of media on computing devices, and, more particularly, to the presentation of multimedia presentations developed in a particular format on devices that do not support such format.

### BACKGROUND

The visual presentation of information has, and likely will remain, one key component for communication among business people, academics, and the population generally. The inclusion of multimedia content in what would otherwise be a “static” presentation has further increased the use of visual presentations. One such tool, PowerPoint™, by Microsoft Corporation of Redmond, Wash. has been a market leader (at least in terms of sales and market share) for over a decade. Others, such as Impress, by the OpenOffice Foundation and Google Docs Presentations by Google, Inc. of Mountain View, Calif. are also widely used. Each program, however, uses a different file format (in some cases markedly different) and may include proprietary features that are not available when a presentation is “ported” or “converted” into a new program for either additional content additions, edits and/or viewing.

One such example is the ability to view multimedia, color, font and other creative aspects of a PowerPoint presentation on certain hand-held or mobile computing devices that utilize the iOS family of operating systems. More specifically, because of certain technical and legal limitations, an accurate rendering of a multimedia PowerPoint presentation on an iPad or iPhone is not possible.

What is needed, therefore, is an application and supporting technical systems that facilitate the translation and presentation of a multimedia visual presentation on platforms that would not otherwise permit or be able to render the presentations.

The foregoing examples of the related art and limitations related therewith are intended to be illustrative and not exclusive. Other limitations of the related art will become apparent upon a reading of the specification and a study of the drawings.

### SUMMARY OF THE INVENTION

A new approach is proposed that contemplates systems and methods to facilitate the rendering and viewing of multimedia presentations on devices that otherwise do not support such features. As a result, users of various presentation preparation and display programs are able to make their work product available for viewing on various hardware and software platforms on which the presentations would not otherwise be rendered correctly. In general, multimedia presentations are created by a user/author in their original format and uploaded to a centralized repository. The uploaded presentations are then converted to a set of intermediate files in a format different from the original format of the presentations, wherein the intermediate files can be downloaded to and rendered on the hardware and software platform of a specific device associated with a viewer. The resulting file is presented in a manner such that the visual and audio integrity of the original presentation is maintained.

### BRIEF DESCRIPTION OF THE DRAWINGS

FIG. 1 depicts an example of a system diagram 100 to support multi-device rendering of multimedia presentations.

FIG. 2 depicts an example of a flowchart of a process to support multi-device rendering of multimedia presentations.

FIG. 3 depict an example of sharing and rendering a multimedia presentation generated on one type of computing device on another.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

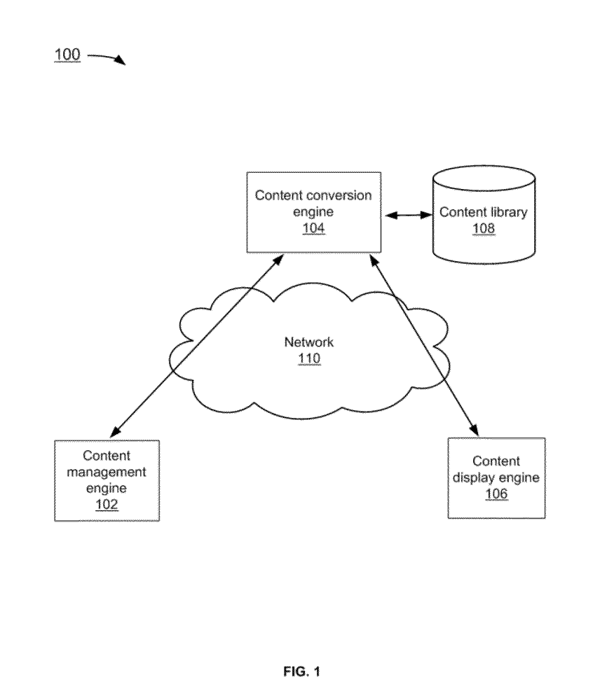

FIG. 1 depicts an example of a system diagram 100 to support multi-device rendering of multimedia presentations. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least a content management engine 102, a content conversion engine 104, a content display engine 106, and a content library 108 coupled to the content conversion engine 104. As used herein, the term “engine” is used to refer to software, firmware, hardware, or other component(s) that are used to effectuate a functional purpose. The engine typically includes software instructions that are stored in non-volatile memory (also referred to as secondary memory). When the software instructions are executed, at least a subset of the software instructions are loaded into memory (also referred to as primary memory) by a processor. The processor then executes the software instructions in memory. The processor may be a shared processor, a dedicated processor, or a combination of shared or dedicated processors. A typical program includes calls to hardware components (such as I/O devices), which typically requires the execution of drivers. The drivers may or may not be considered part of the engine, but the distinction is not critical.

As used herein, the term library or database is used broadly to include any known or convenient means for storing data, whether centralized or distributed, relational or otherwise. Some or all of the functional components described herein may be stored and operate remotely from the users, utilizing shared processing and storage facilities across one or more service providers. Essentially, the entire content creation, conversion, storage and presentation process may, in some embodiments, be provided as a shared service or “cloud-based” application.

In the example of FIG. 1, each of the engines and library can run on one or more hosting devices (hosts). Here, a host can be a computing device, a communication device, a storage device, or any electronic device capable of running a software component. For non-limiting examples, a computing device can be but is not limited to a laptop PC, a desktop PC, a tablet PC, a touch screen mobile or handheld device, wireless communication device such as a smartphone, or a PDA, or a server machine. A storage device can be but is not limited to a hard disk drive, a flash memory drive, or any portable storage device. A communication device can be but is not limited to a mobile phone.

In the example of FIG. 1, content management engine 102, content conversion engine 104, content display engine 106, and content library 108 each has a communication interface (not shown), which is a software component enabling the engines to communicate with each other using certain communication protocols, such as TCP/IP, over one or more communication networks 110. Here, communication network 110 can be but is not limited to, the Internet, a private intranet, wide area network (WAN), local area network (LAN), wireless network, cellular (e.g., 3G, 4G, LTE), Bluetooth, WiFi, and mobile communication networks. The physical connections of the network and the communication protocols are well known to those of skill in the art.

In the example of FIG. 1, content management engine 102 provides a web-based content management service to a user/author, which enables the user to upload, access, and manage one or more presentation files created in a first/original file format and store the file to a centralized location over the Internet. More specifically, the user having created a presentation file having multimedia content embedded therein, may upload the file into the cloud-based content library/repository 108. Here, the content of a multimedia presentation includes but is not limited to, one or more of texts, audio files that play during the presentation of a slide, videos that play during a slide, pictures, animations, graphics, drawings, and other types of contents suitable to be included and rendered in a file in electronic formats. Content library/repository 108 may be located at a centralized physical location (or a plurality of co-managed locations) managed by content management engine 102 for maintaining and storing of the uploaded and/or converted files related to the multimedia presentations. Content library/repository 108 can be accessed either as a free service or a subscription-based service that may include features such as free sharing, hosting and editing capabilities.

In some embodiments, content management engine 102 enables the user/author to access and download a content generating software application from a central application repository onto a computing device of her choice, which can be but is not limited to, a desktop, a laptop, a tablet, a handheld or mobile device. Such content generating app allows the user to create rich multimedia presentations for sharing and viewing by others, regardless of the devices on which the presentations will be rendered and viewed. In some embodiments, the app may also access and communicate remotely with content conversion engine 104 as well as content display engine 106 to perform some of the conversion or rendering tasks.

In some embodiments, content management engine 102 may require the user to provide authentication credentials (e.g., a user ID, password, or other identification key) in order to identify herself and gain access to the content management service provided by content management engine 102. In some embodiments, content management engine 102 may also facilitate the sharing of presentation files among other people/viewers, such as coworkers, clients, students or the general public. Such users may, in some cases, access and download the files of the presentations for viewing, commenting, and editing on their own computing devices under the authorization and access control by the user. Here, the computing device to which the files are downloaded and viewed may be a handheld or mobile device, tablet, laptop, desktop or other computing device, which may be separate from (and in some cases utilize a different operating system than) the computing device used by the user to create the file. Other differences among the device used to create the presentation and the device used to view the presentation, such as legal and/or licensing limitations, may also require the interim conversion process described herein.

In the example of FIG. 1, content conversion engine 104 converts the presentation files generated and uploaded by the user via content management engine 102 from their original format (e.g., .PPT/.PPTX files for PowerPoint or Flash for Adobe©) to one or more intermediate files in a second file format that may be rendered or viewed on a handheld or mobile device while maintaining the visual and audio integrity of the original presentation. Here, content conversion engine 104 may run on a server-based software and supporting systems. The handheld or mobile device may be a non-native device, i.e., a device that supports rendering of the presentation in the intermediate format but not the file format in which the presentation was originally created by the user. Without the files being converted to the intermediate format first by content conversion engine 104, the handheld or mobile device would otherwise not able to render the presentation files and the multimedia content contained in the files properly and in the original format as intended by the author.

In some embodiments, the content conversion engine 104 initiates the conversion process of the presentation file by retrieving the presentation file from the content library 108 and identifying both the original format of the presentation file (e.g., .PPT, Flash) and the desired format of the intermediate file (e.g., HTML5, WMV, MPEG, AVI, etc.) to be rendered on the hardware/software platform of the specific handheld or mobile device. In some embodiments, the content conversion engine 104 may enable the user to select from a detailed list of video and/or audio options, which include but are not limited to, resolution, compression standards, output destinations, etc., for the conversion of the file of the multimedia presentation.

In some embodiments, content conversion engine 104 parses the original presentation file to determine the number of on-click animation events and the length of each animation event in each slide/page of the file once the conversion process is initiated. Here, an animation event may include, for non-limiting examples, the introduction of a new text box onto a slide, the playing of an embedded movie or audio clip, the fading in or out of a static image, and/or the transition to a new slide page in the presentation file. The content conversion engine 104 then creates a separate movie/video file out of each slide of the presentation file based on the animation events identified in each slide. The duration of each video is determined by calculating the number of on-click animations and examining the actual length of each animation sequence on each slide. Content conversion engine 104 may also create a metadata file associated with each video file that contains information representing the number and duration location (e.g., mm:ss) of each on-click event on the page. In some embodiments, the content conversion engine 104 may further process each of the movie/video files to create a compressed video file for each slide/page of the presentation for rendering on various devices of the viewers.

In some embodiments, the content conversion engine 104 may also embed additional multimedia features such as hyperlinks, action buttons, playback of embedded movies, playback of animated GIFs (when waiting for on-click) or other third-party presentation program components in the video files during the conversion process.

In the example of FIG. 1, the content display engine 106 utilizes a device-based application running on a specific computing device, wherein the device-based application synchronizes with the content management engine 102, downloads presentation files in the intermediate format from the content conversion engine 104 and renders the files to be viewed by a user/viewer on the specific computing device, which supports the intermediate, but not the original file format. Here, the specific computing device can be a non-native device, which can be but is not limited to a mobile, tablet or hand held device.

In some embodiments, the device-based application can be accessed and downloaded (in some cases purchased) from an application repository (e.g., the Apple App Store, the Android Marketplace, etc.). A user/viewer installs the app and authenticates the particular instance of the app with the content display engine 106 using the same credentials used to access the content management service. Once the viewer and the associated app instance is authenticated, the content display engine 106 downloads metadata associated with the presentation file (e.g., title, author, date created, date last accessed, duration, topic, etc.) from the content conversion engine 104 onto the handheld/mobile device and provides the viewer with a list of presentations available for rendering on the device.

After a presentation has been selected by the viewer, the content display engine 106 places the presentation file in a download queue and prompts the viewer to confirm that this particular presentation is to be downloaded, and if so, which communication method (wireless, 3G, 4G, etc.) is to be utilized for the download. The content display engine 106 then downloads both the individual video files of the presentation and their associated metadata files containing the slide-specific times and transition points to the device via the device application. In some embodiments, content display engine 106 may interrupt the download of the entire presentation at any time if connectivity in lost and later resume the download from the location where it is interrupted when connectivity is restored.

In some embodiments, the content display engine 106 renders the presentation on the device associated with the viewer after the entire set of files are transferred to the device and no connectivity to the Internet is required for the viewer to view the presentation once the presentation has been transferred. The device application of the content display engine 106 plays all the downloaded video files as requested until it encounters the next on-click event on a page/slide, at which point the application pauses and waits for the next viewer instruction. As a non-limiting example, the device application of the content display engine 106 supports and accepts the following gestures by the viewer on a touch-screen devices:
Single tap—Play animation and proceed to next on-click timing
Swipe back—Return to the beginning of the current slide
Swipe forward—Go to next slides
Swipe Up—show table of contents
Tap & hold—expose tools: laser pointer or marking tools

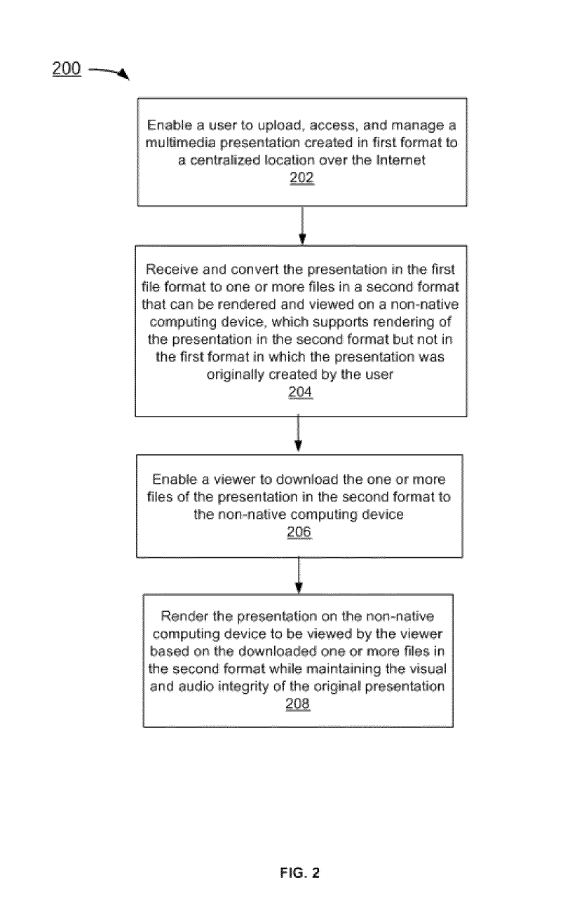

FIG. 2 depicts an example of a flowchart of a process to support multi-device rendering of multimedia presentations. Although this figure depicts functional steps in a particular order for purposes of illustration, the process is not limited to any particular order or arrangement of steps. One skilled in the relevant art will appreciate that the various steps portrayed in this figure may be omitted, rearranged, combined and/or adapted in various ways.

In the example of FIG. 2, the flowchart 200 starts at block 202 where a user is enabled to upload, access, and manage a multimedia presentation created in first format to a centralized location over the Internet. The flowchart 200 continues to block 204 where the presentation in the first file format is received and converted to one or more files in a second format that can be rendered and viewed on a non-native computing device, which supports rendering of the presentation in the second format but not in the first format in which the presentation was originally created by the user. The flowchart 200 continues to block 206 where a viewer is enabled to download the one or more files of the presentation in the second format to the non-native computing device. The flowchart 200 ends at block 208 where the presentation is rendered on the non-native computing device to be viewed by the viewer based on the downloaded one or more files in the second format while maintaining the visual and audio integrity of the original presentation.

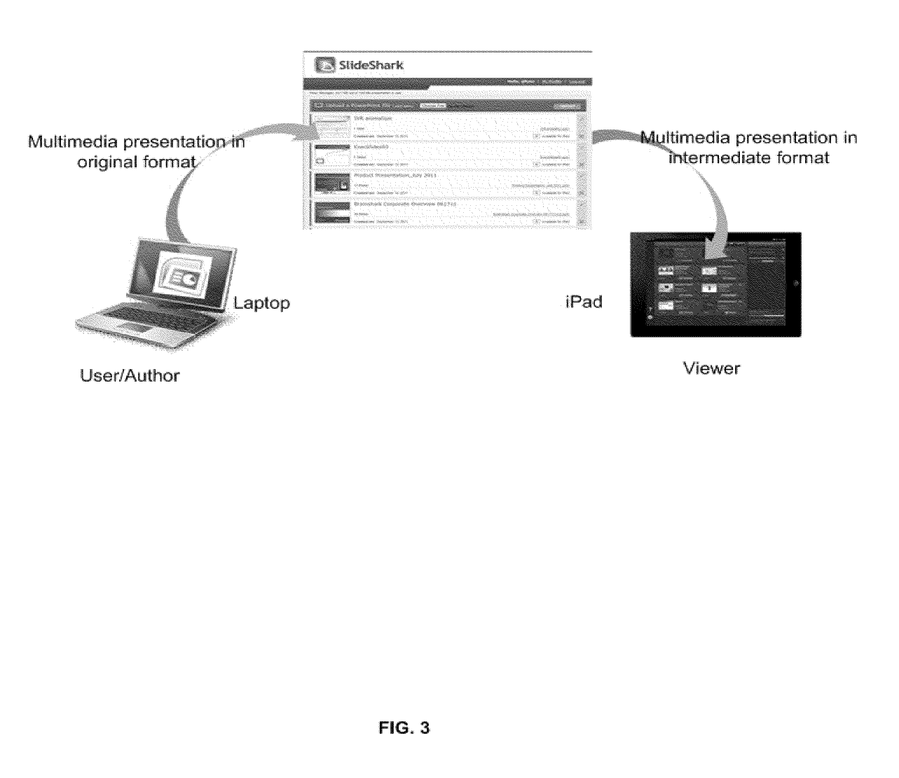

Under the approach discussed above, multimedia contents/presentations that would otherwise not be rendered properly on certain types of devices can be now be viewed by viewers of such devices with audio/video fidelity. As shown in the non-limiting example depicted in FIG. 3, multimedia presentations containing videos created by a user/author on a conventional PC/laptop that supports the original format (e.g., Adobe Flash) cannot be viewed properly on another hardware device which only support HTML5 (e.g., Apple products running iOS operating systems, such as iPhone and iPad). By uploading and converting the files of the presentations to a different/intermediate format (e.g., HTML5) at a centralized server over the Internet, the authors of these multimedia presentations can now share the presentations with viewers, who may then download and render the presentation on their associated devices of choice while preserving the fidelity of the original presentations.

It is understood that the methods and systems described above may be implemented using various software and hardware components connected to the Internet via a network. Computing devices are capable of communicating with each other via the Internet, and it should be appreciated that the various functionalities of the components may be implemented on any number of devices.

Those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

What is claimed is:

1. A system, comprising:
a content management engine, which in operation, enables a user to upload, access, and manage a multimedia presentation created in first format to a centralized location over the Internet;
a content conversion engine, which in operation, receives and converts the presentation in the first file format to one or more files in a second format that can be rendered and viewed on a non-native computing device, which supports rendering of the presentation in the second format but not in the first format in which the presentation was originally created by the user;
a content display engine, which in operation,
enables a viewer to download the one or more files of the presentation in the second format to the non-native computing device; and
renders the presentation on the non-native computing device to be viewed by the viewer based on the downloaded one or more files in the second format while maintaining the visual and audio integrity of the original presentation.

2. The system of claim 1, further comprising:
a content library for maintaining and storing the uploaded and/or converted files of the multimedia presentation.

3. The system of claim 1, wherein:
the non-native computing device is a handheld or mobile device.

4. The system of claim 1, wherein:
the non-native computing device is a product running iOS operating systems.

5. The system of claim 1, wherein:
the first format is one of PPT/PPTX for PowerPoint or Flash for Adobe© software.

6. The system of claim 1, wherein:
the second format is one of HTML5, WMV, MPEG, AVI.

7. The system of claim 1, wherein:
content management engine enables the user to access and download a content generating software application from a central application repository onto a computing device to create the multimedia presentation.

8. The system of claim 1, wherein:
content management engine requires the user to provide authentication credentials in order to identify him/herself for access to content management service provided.

9. The system of claim 1, wherein:
content management engine enables the viewer to access and download the files of the presentations to the non-native computing device under authorization and access control by the user.

10. The system of claim 1, wherein:
content conversion engine identifies both the original first format of the presentation and the desired second format of the one or more files to be rendered under hardware/software platform of the non-native computing device.

11. The system of claim 1, wherein:
content conversion engine enable the user to select from a detailed list of video and/or audio options for the conversion of the multimedia presentation.

12. The system of claim 1, wherein:
content conversion engine parses the presentation to determine the number of on-click animation events and the length of each of the animation events on each slide/page of the presentation.

13. The system of claim 12, wherein:
content conversion engine creates a separate movie/video file for each slide of the presentation based on the animation events identified in each slide.

14. The system of claim 13, wherein:
content conversion engine creates a metadata file associated with each video file that contains information representing the number and duration location of every on-click event on the page.

15. The system of claim 13, wherein:
content conversion engine processes each of the movie/video files to create a compressed video file for each slide/page of the presentation for rendering on the non-native computing device.

16. The system of claim 13, wherein:
content conversion engine embeds additional multimedia features or third party presentation program components in the video files.

17. The system of claim 1, wherein:
content display engine utilizes a device-based application for downloading the one or more files in the second format and rendering the presentation on the non-native computing device.

18. The system of claim 17, wherein:
content display engine enables the viewer to access and download the device-based application from an application repository based on the viewer's credentials.

19. The system of claim 14, wherein:
content display engine downloads both the one or more files of the presentation and their associated metadata files containing the slide-specific times and transition points to the non-native computing device.

20. The system of claim 12, wherein:
content display engine plays the downloaded files until it encounters the next on-click event on the page/slide, at which point it pauses and waits for the viewer to instruct what to do next.

21. A method, comprising:
enabling a user to upload, access, and manage a multimedia presentation created in first format to a centralized location over the Internet;
receiving and converting the presentation in the first file format to one or more files in a second format that can be rendered and viewed on a non-native computing device, which supports rendering of the presentation in the second format but not in the first format in which the presentation was originally created by the user;
enabling a viewer to download the one or more files of the presentation in the second format to the non-native computing device;
rendering the presentation on the non-native computing device to be viewed by the viewer based on the downloaded one or more files in the second format while maintaining the visual and audio integrity of the original presentation.

22. The method of claim 21, further comprising:
enabling the user to access and download a content generating software application from a central application repository onto a computing device to create the multimedia presentation.

23. The method of claim 21, further comprising:
requiring the user to provide authentication credentials in order to identify him/herself for access to content management service provided.

24. The method of claim 21, further comprising:
enabling the viewer to access and download the files of the presentations to the non-native computing device under authorization and access control by the user.

25. The method of claim 21, further comprising:
identifying both the original first format of the presentation and the desired second format of the one or more files to be rendered under hardware/software platform of the non-native computing device.

26. The method of claim 21, further comprising:
enabling the user to select from a detailed list of video and/or audio options for the conversion of the multimedia presentation.

27. The method of claim 21, further comprising:
parsing the presentation to determine the number of on-click animation events and the length of each of the animation events on each slide/page of the presentation.

28. The method of claim 27, further comprising:
creating a separate movie/video file for each slide of the presentation based on the animation events identified in each slide.

29. The method of claim 28, further comprising:
creating a metadata file associated with each video file that contains information representing the number and duration location of every on-click event on the page.

30. The method of claim 28, further comprising:
processing each of the movie/video files to create a compressed video file for each slide/page of the presentation for rendering on the non-native computing device.

31. The method of claim 28, further comprising:
embedding additional multimedia features or third party presentation program components in the video files.

32. The method of claim 21, further comprising:
utilizing a device-based application for downloading the one or more files in the second format and rendering the presentation on the non-native computing device.

33. The method of claim 32, further comprising:
enabling the viewer to access and download the device-based application from an application repository based on the viewer's credentials.

34. The method of claim 29, further comprising:
downloading both the one or more files of the presentation and their associated metadata files containing the slide-specific times and transition points to the non-native computing device.

35. The method of claim 27, further comprising:
playing the downloaded files until encountering the next on-click event on the page/slide, at which point pausing and waiting for the viewer to instruct what to do next.
